(19) United States
(12) Patent Application Publication
(10) Pub. No.: US 2013/0106885 A1
(43) Pub. Date: May 2, 2013

(54) ALIASING OF LIVE ELEMENTS IN A USER INTERFACE

(71) Applicants: Brendan J. Clark, Seattle, WA (US); Ruurd Johan Boeke, Redmond, WA (US); Gerhard Schneider, Seattle, WA (US); Terry A. Adams, North Bend, WA (US); Hamid Mahmood, Seattle, WA (US); Bede Jordan, Seattle, WA (US)

(72) Inventors: Brendan J. Clark, Seattle, WA (US); Ruurd Johan Boeke, Redmond, WA (US); Gerhard Schneider, Seattle, WA (US); Terry A. Adams, North Bend, WA (US); Hamid Mahmood, Seattle, WA (US); Bede Jordan, Seattle, WA (US)

(73) Assignee: MICROSOFT CORPORATION, Redmond, WA (US)

(21) Appl. No.: 13/287,654

(22) Filed: Nov. 2, 2011

(51) Int. Cl. G06T 13/20

(52) U.S. Cl. 345/581

(57) ABSTRACT

Embodiments are directed to maintaining layout properties when aliasing a live element and to independently inheriting animation properties using aliases. In one scenario, a computer system generates aliases for a live element displayed in a user interface (UI). The aliases represent the live element in a UI layout which includes live element properties that are inherited hierarchically. The computer system removes the live element from the UI such that the live element is no longer visible on the UI, and integrates the generated aliases into the UI layout. The aliases inherit properties of the UI layout depending on where in the layout the alias was attached. The computer system then initiates an animation for the live element using the aliases which are integrated into the UI layout according to the properties inherited from the position of the aliases in the layout.

### BACKGROUND

Computers have become highly integrated in the workforce, in the home, in mobile devices, and many other places. Computers can process massive amounts of information quickly and efficiently. Software applications designed to run on computer systems allow users to perform a wide variety of functions including business applications, schoolwork, entertainment and more. Software applications are often designed to perform specific tasks, such as word processor applications for drafting documents, or email programs for sending, receiving and organizing email.

These software applications have user interfaces which allow users to interact with and control the applications. The user interfaces typically have different content items including icons, text, menus and other selectable items which, when activated, perform a desired function. In some cases, icons or other content items will be moved, rotated or otherwise edited by a user. These movements, rotations or other changes may be animated according to operating system (OS) animation properties and/or application-specific animation properties. The animation properties may be inherited based on where the content item fits into a hierarchical tree.

### BRIEF SUMMARY

Embodiments described herein are directed to maintaining layout properties when aliasing a live element and to independently inheriting animation properties using aliases. In one embodiment, a computer system generates aliases for a live element displayed in a user interface (UI). The aliases represent the live element in a UI layout which includes live element properties that are inherited hierarchically. The computer system removes the live element from the UI such that the live element is no longer visible on the UI, and integrates the generated aliases into the UI layout. The aliases inherit properties of the UI layout depending on where in the layout the alias was attached. The computer system then initiates an animation for the live element using the aliases which are integrated into the UI layout according to the properties inherited from the position of the aliases in the layout.

In another embodiment, a computer system receives an indication that a live element is to be moved from an original position in a user interface (UI) layout to a new position in the UI layout. The computer system generates an alias for the live element which represents the live element in the UI layout. The UI layout includes live element properties that are inherited hierarchically based on where the live element is positioned in the UI layout. The computer system integrates the generated alias into the UI layout. The alias inherits at least one property from the live element's original position in the UI layout and at least one property from the new position in the UI layout. The computer system then initiates an animation for the live element using the alias which is integrated into the UI layout according to the properties inherited from the original and new positions of the alias in the UI layout, and displays the live element in the second, different position upon completion of the animation.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be apparent to one of ordinary skill in the art from the description, or may be learned by the practice of the teachings herein. Features and advantages of embodiments of the invention may be realized and obtained by means of the instruments and combinations particularly pointed out in the appended claims. Features of the embodiments of the present invention will become more fully apparent from the following description and appended claims, or may be learned by the practice of the invention as set forth hereinafter.

### BRIEF DESCRIPTION OF THE DRAWINGS

To further clarify the above and other advantages and features of embodiments of the present invention, a more particular description of embodiments of the present invention will be rendered by reference to the appended drawings. It is appreciated that these drawings depict only typical embodiments of the invention and are therefore not to be considered limiting of its scope. The embodiments of the invention will be described and explained with additional specificity and detail through the use of the accompanying drawings in which:

FIG. 1 illustrates a computer architecture in which embodiments of the present invention may operate including maintaining layout properties when aliasing a live element and independently inheriting animation properties using aliases.

FIG. 2 illustrates a flowchart of an example method for maintaining layout properties when aliasing a live element.

FIG. 3 illustrates a flowchart of an example method for independently inheriting animation properties using aliases.

FIG. 4 illustrates an embodiment in which a listbox element is moved positions while retaining certain properties.

### DETAILED DESCRIPTION

Embodiments described herein are directed to maintaining layout properties when aliasing a live element and to independently inheriting animation properties using aliases. In one embodiment, a computer system generates aliases for a live element displayed in a user interface (UI). The aliases represent the live element in a UI layout which includes live element properties that are inherited hierarchically. The computer system removes the live element from the UI such that the live element is no longer visible on the UI, and integrates the generated aliases into the UI layout. The aliases inherit properties of the UI layout depending on where in the layout the alias was attached. The computer system then initiates an animation for the live element using the aliases which are integrated into the UI layout according to the properties inherited from the position of the aliases in the layout.

In another embodiment, a computer system receives an indication that a live element is to be moved from an original position in a user interface (UI) layout to a new position in the UI layout. The computer system generates an alias for the live element which represents the live element in the UI layout. The UI layout includes live element properties that are inherited hierarchically based on where the live element is positioned in the UI layout. The computer system integrates the generated alias into the UI layout. The alias inherits at least one property from the live element's original position in the UI layout and at least one property from the new position in the UI layout. The computer system then initiates an animation for the live element using the alias which is integrated into the UI layout according to the properties inherited from the original and new positions of the alias in the UI layout, and displays the live element in the second, different position upon completion of the animation.

The following discussion now refers to a number of methods and method acts that may be performed. It should be noted, that although the method acts may be discussed in a certain order or illustrated in a flow chart as occurring in a particular order, no particular ordering is necessarily required unless specifically stated, or required because an act is dependent on another act being completed prior to the act being performed.

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions in the form of data are computer storage media. Computer-readable media that carry computer-executable instructions are transmission media. Thus, by way of example, and not limitation, embodiments of the invention can comprise at least two distinctly different kinds of computer-readable media: computer storage media and transmission media.

Computer storage media includes RAM, ROM, EEPROM, CD-ROM, solid state drives (SSDs) that are based on RAM, Flash memory, phase-change memory (PCM), or other types of memory, or other optical disk storage, magnetic disk storage or other magnetic storage devices, or any other medium which can be used to store desired program code means in the form of computer-executable instructions, data or data structures and which can be accessed by a general purpose or special purpose computer.

A “network” is defined as one or more data links and/or data switches that enable the transport of electronic data between computer systems and/or modules and/or other electronic devices. When information is transferred or provided over a network (either hardwired, wireless, or a combination of hardwired or wireless) to a computer, the computer properly views the connection as a transmission medium. Transmissions media can include a network which can be used to carry data or desired program code means in the form of computer-executable instructions or in the form of data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a network interface card or “NIC”), and then eventually transferred to computer system RAM and/or to less volatile computer storage media at a computer system. Thus, it should be understood that computer storage media can be included in computer system components that also (or even primarily) utilize transmission media.

Computer-executable (or computer-interpretable) instructions comprise, for example, instructions which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems that are linked (either by hardwired data links, wireless data links, or by a combination of hardwired and wireless data links) through a network, each perform tasks (e.g. cloud computing, cloud services and the like). In a distributed system environment, program modules may be located in both local and remote memory storage devices.

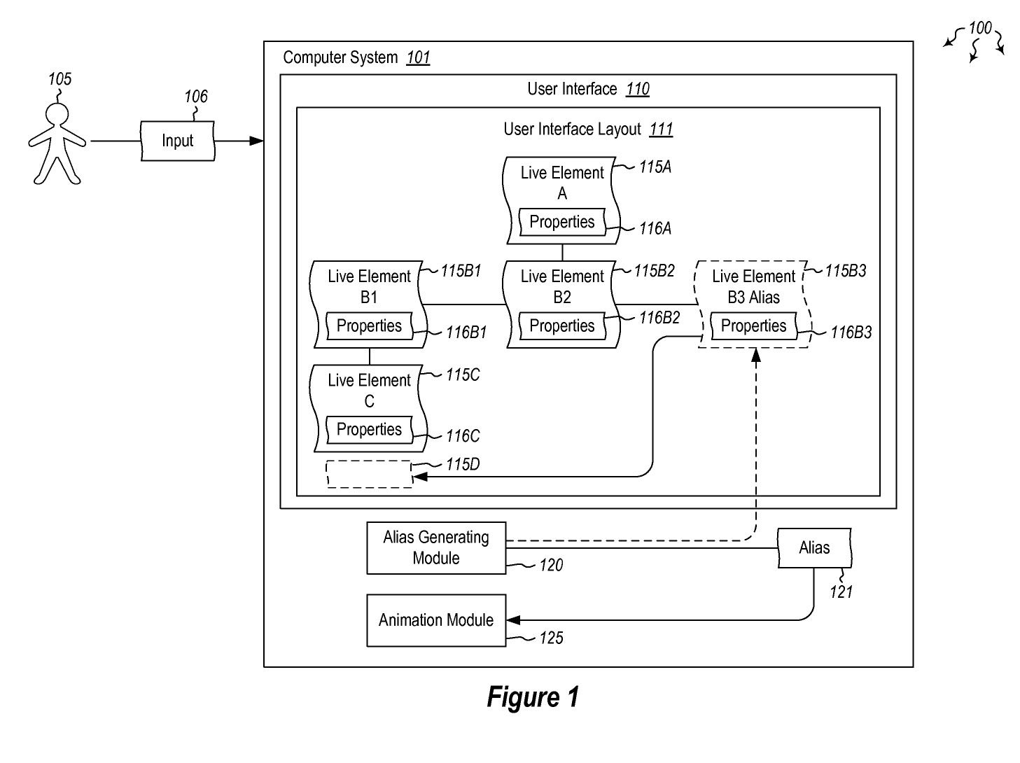

FIG. 1 illustrates a computer architecture 100 in which the principles of the present invention may be employed. Computer architecture 100 includes computer system 101. Computer system 101 may be any type of local, remote or distributed computer system (including a cloud computing system). The computer system may be configured to run an operating system and various different software applications. Both the operating system and the software applications may have user interfaces (e.g. user interface (or UI) 110. UI 110 includes a user interface layout (or UI layout) 111. The layout may include a variety of different elements including icons, pictures, listboxes, menus, toolbars or other elements. The user may interact with the software application and operating system using these elements. As such, these elements may represent different types of functionality, different files, or other forms of interaction with the computing system's software.

Each element of the user interface layout 111 may include different properties. Live elements, as used herein, refer to elements that allow interaction with a software application. These live elements are capable of being reconfigured, rearranged, animated or otherwise manipulated by the computer system. When animations are performed on the elements (such as when an icon is added, deleted or moved to a new position), they are performed using the corresponding element's properties. Thus, if live element A (115A) is to be animated, the animation will be performed using properties 116A. Similarly, if elements B1 (115B1), B2 (115B2), B3 (115B3) or C (115C) are animated, they will be animated according to corresponding properties 116B1, 116B2, 116B3 or 116C, respectively. As shown in user interface layout 111, the elements may be arranged in a hierarchical fashion. In some cases, element properties may be inherited from elements that are higher in the hierarchy (or are closer to the root, depending on how the hierarchy is viewed). This concept will be explained in greater detail below.

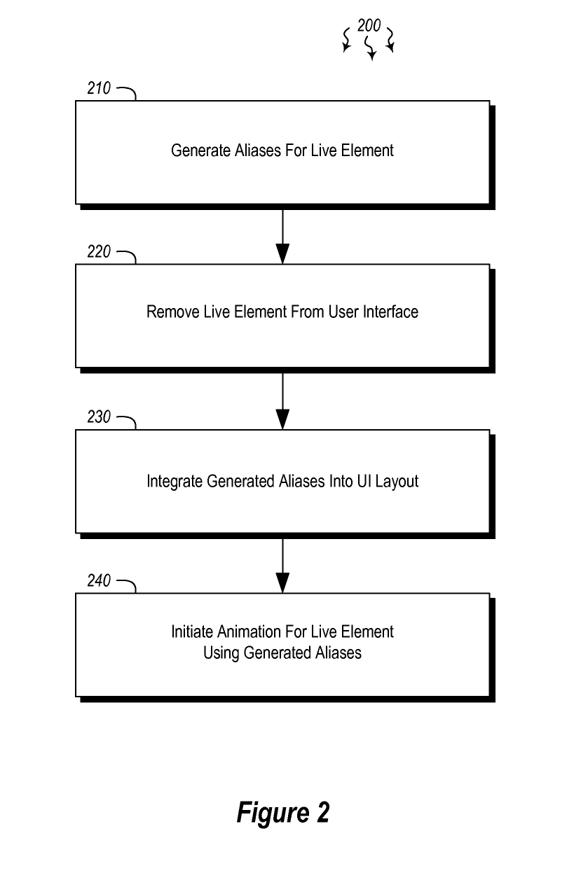

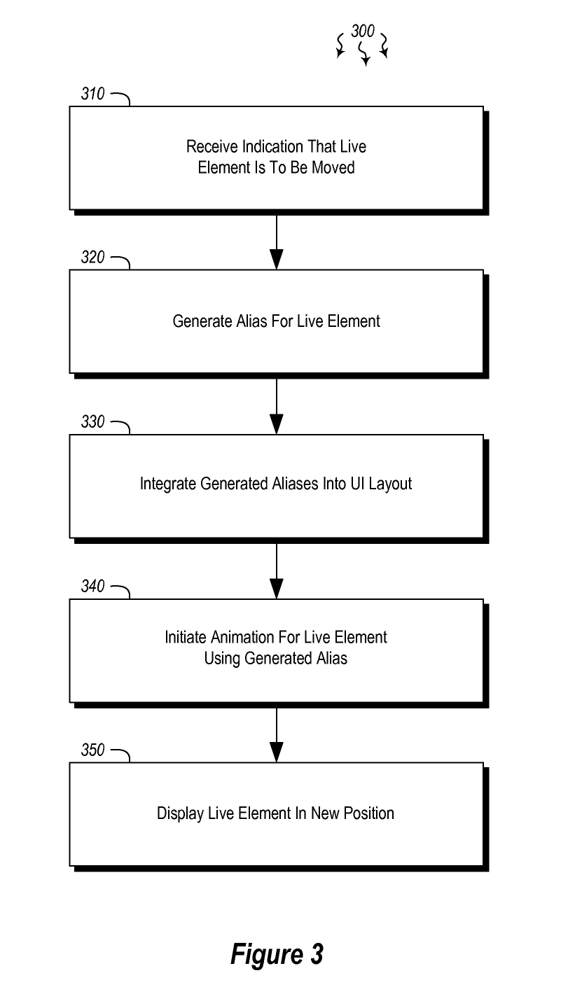

In some cases, when a live element is animated, multiple versions of that element will be shown at the same time. In such cases, an alias 121 may be created by alias generating module 120. This alias may be used as a representation of the live element for which multiple versions are to be shown. This alias may then represent the original live element while the original live element is removed from the screen. The alias may be attached within the hierarchical tree as if it were the original element. The animation module 125 may then use the alias when rendering the animation. This process will be described in greater detail below with regard to methods 200 and 300 of FIGS. 2 and 3, respectively.

In view of the systems and architectures described above, methodologies that may be implemented in accordance with the disclosed subject matter will be better appreciated with reference to the flow charts of FIGS. 2 and 3. For purposes of simplicity of explanation, the methodologies are shown and described as a series of blocks. However, it should be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

FIG. 2 illustrates a flowchart of a method 200 for maintaining layout properties when aliasing a live element. The method 200 will now be described with frequent reference to the components and data of environment 100.

Method 200 includes an act of generating one or more aliases for a live element displayed in a user interface (UI), the aliases representing the live element in a UI layout, the UI layout comprising live element properties that are inherited hierarchically (act 210). For example, alias generating module 120 may generate various different aliases 121 for a live element (e.g. element A (115A)) in user interface 110. As mentioned above, the aliases may be used to represent the live element during an animation. Thus, if element A is being animated, and that animation removes element A from the screen, the alias may be displayed in its place. Accordingly, the end user 105 would see the alias instead of the actual live element that is being animated.

In one embodiment, the user interface 110 of computer system 101 may receive an indication 106 that a live element is to be moved from an original position in the UI layout to a new and different position in the UI layout 111. The alias generating module 120 determines which type of animation is being performed (e.g. a change in opacity, a change in scale/size, a change in location, a rotational change or other change). Then, based on the determined type of animation, the alias generating module generates an animation 121. In some cases, the generation of an alias may be automatically triggered whenever an animation (of any element) has been initiated.

Continuing the above example, the generated animation moves the live element from its original position in the UI layout to a new, different position in the UI layout. For instance, live element B3 (115B3) may be moved from its original position next to element B2 (115B2) and below element A (115A) to its new position below live element C (115C). The generated alias 121 may be shown in place of element B3 at element B3's original position. In some cases, another alias may be displayed in addition to the first alias, at the new location of element B3 below element C. Accordingly, multiple aliases corresponding to the same live element may be displayed simultaneously.

Next, method 200 includes an act of removing the live element from the UI such that the live element is no longer visible on the UI (act 220). Thus, in the example above, element B3 is removed from UI layout 111 of UI 110. The element may be removed as part of an animation and, as such, may fade out or may be moved to another position on the screen, or otherwise animated when it is removed. In some cases, the live element that is removed (e.g. B3), is (at least logically) rendered into a data buffer which is editable by the generated aliases.

Method 200 also includes an act of integrating the generated aliases into the UI layout, wherein the aliases inherit properties of the UI layout depending on where in the layout the alias was attached (act 230). Computer system 101 may integrate alias 121 into UI layout 111. The aliases inherit properties of the UI layout depending on an established parent/child hierarchy. For instance, if the alias is placed in row B, in place of element B3, the alias will inherit the properties 116B3 from its parent element (115A). The properties may also be inherited from elements higher in the hierarchy. Thus, for instance, elements on row B may each inherit the properties of the parent element (live element A). Similarly, live element C may inherit the properties of live element A, as well as from live element B1, which are both higher in the hierarchy than element C.

In some case, override inheritance flags may be implemented to override certain properties that would otherwise be inherited. Thus, for example, element B2 may implement an override flag to avoid inheriting the properties from live element A. The override flags may be used to specify exactly which properties will be inherited, and which will not. This allows a developer a great deal of flexibility when deciding how elements will be animated or otherwise used. In some cases, the override inheritance flag may even allow a live element to be positioned arbitrarily within the UI layout 111 without inheriting properties based on the live element's position in the UI layout (or while only inheriting user- or developer-specified properties).

Method 200 then includes an act of initiating an animation for the live element using the one or more aliases which are integrated into the UI layout according to the properties inherited from the position of the aliases in the layout (act 240). For example, animation module 125 may initiate an animation that moves element B3 from its original position next to element B2 to its new position below element C. The alias may be used during the animation to represent element B3 at its original position. Barring the use of any override flags, the alias will be integrated into the UI layout according the properties inherited from row A and/or rows A-C in the element's new position.

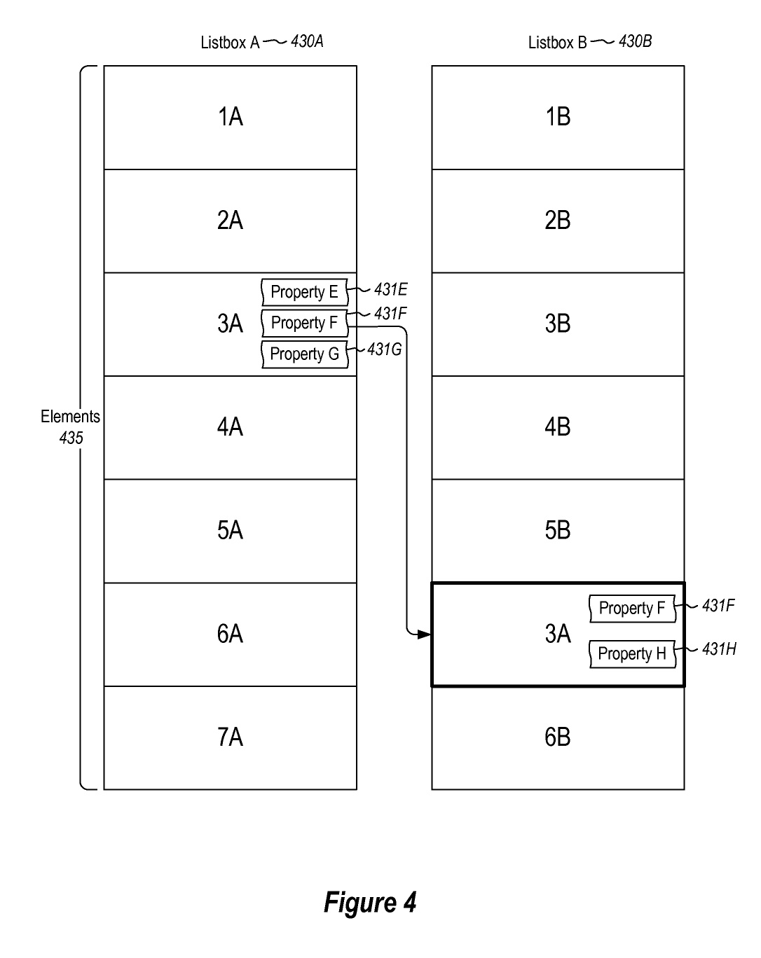

After the animation is complete, the live element (e.g. B3) may be displayed in the new, different position (below element C). As shown in FIG. 4, an element may be moved from one position in a listbox to another position in the listbox. For instance, listbox A (430A) may include multiple different elements 435. Of these elements, element 3A may be moved to a different position, as shown in listbox B (430B). Element 3A has various properties E (431E), F (431F) and G (431G). Some of these properties may be carried into the new listbox (property F), while some of the properties may be removed (or overridden). New properties (e.g. property H (431H) may also be added to the element, based on inheritance and based on any override flags in place.

Thus, a live element may be moved from one hierarchical position in listbox 430A to a new, different hierarchical position in listbox 430B. The movement of the live element between listboxes may, at least in some cases, trigger the generation of aliases that are used for the animation of that live element. Although the element is moved to a new hierarchical position, the computer system may determine that the live element is not to inherit properties from its new hierarchical position in the other listbox, and may place the live element in a root hierarchical position in the other listbox where it will not inherit any properties from the branch nodes.

FIG. 3 illustrates a flowchart of a method 300 for independently inheriting animation properties using aliases. The method 300 will now be described with frequent reference to the components and data of environments 100 and 400 of FIGS. 1 and 4, respectively.

Method 300 includes an act of receiving an indication that a live element is to be moved from a first position in a user interface (UI) layout to a second, different position in the UI layout (act 310). For example, computer system 101 may receive indication 106 from user 105 that live element 3A of listbox 430A is to be moved from its current position in the listbox (between elements 2A and 4A) to a new position in listbox 430B between elements 5B and 6B. The listboxes are one example of a UI layout 111. The listboxes may include a tree of live elements 435 where each live element higher up the tree is drawn on top of the other live elements. Moreover, each element higher up the tree includes additional animation properties the lower live elements do not include. Thus, elements 6A and 6B may include additional animation properties that, for example, elements 1A and 1B do not. Each layer may build on the others. As shown in FIG. 1, multiple elements may be positioned at each layer of the tree.

Alias generating module 120 of computer system 101 may be used to generate an alias for the live element that is to be moved (3A) which represents the live element in the UI layout (act 320). The UI layout 111 (or listbox 430A/B) includes various live element properties that are inherited hierarchically based on where the live element is positioned in the UI layout. The computer system integrates the generated alias into the UI layout, where the alias inherits at least one property from the live element's original position in the UI layout and at least one property from the new position in the UI layout (act 330). As mentioned above, element 3A which includes properties 431E, 431F and 431G may be moved to its new position between elements 5B and 6B. The alias may be configured to inherit or override inheritance from any part of the hierarchy in the UI layout. These inheritance properties may be specified by a developer and/or by an end user. In some cases, the property inheritance for each specific alias is customizable by a developer or other user.

Method 300 also includes an act of initiating an animation for the live element using the alias 121 which is integrated into the UI layout according to the properties inherited from the original and new positions of the alias in the UI layout (act 340). The alias may thus be implemented to draw the live element (3A) in the new position on listbox 430B with new animation properties, without affecting the original UI layout. The computer system may then display the live element in the new position upon completion of the animation (act 350).

Accordingly, methods, systems and computer program products are provided which maintain layout properties when aliasing a live element. Moreover, methods, systems and computer program products are provided which independently inherit animation properties using aliases.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. At a computer system including at least one processor and a memory, in a computer networking environment including a plurality of computing systems, a computer-implemented method for maintaining layout properties when aliasing a live element, the method comprising:
an act of generating one or more aliases for a live element displayed in a user interface (UI), the aliases representing the live element in a UI layout, the UI layout comprising live element properties that are inherited hierarchically;
an act of removing the live element from the UI such that the live element is no longer visible on the UI;
an act of integrating the generated aliases into the UI layout, wherein the aliases inherit properties of the UI layout depending on where in the layout the alias was attached; and
an act of initiating an animation for the live element using the one or more aliases which are integrated into the UI layout according to the properties inherited from the position of the aliases in the layout.

2. The method of claim 1, further comprising an act of receiving an indication that the live element is to be moved from a first position in the UI layout to a second, different position in the UI layout.

3. The method of claim 2, further comprising an act of displaying the live element in the second, different position upon completion of the animation.

4. The method of claim 1, wherein the one or more aliases are generated based on the type of animation being performed.

5. The method of claim 1, wherein the aliases are generated upon determining that an animation has been initiated on the live element.

6. The method of claim 5, wherein the animation is configured to move the live element from a first position in the UI layout to a second, different position in the UI layout.

7. The method of claim 1, wherein multiple aliases corresponding to the same live element are displayed simultaneously.

8. The method of claim 1, further comprising implementing an override inheritance flag that overrides properties inherited from the live element's position in the UI layout.

9. The method of claim 8, wherein the override inheritance flag allows the live element to be positioned arbitrarily within the UI layout without inheriting properties based on the live element's position in the UI layout.

10. The method of claim 1, wherein the live element is moved from a first hierarchical position in a first listbox to a second, different hierarchical position in a second, different listbox.

11. The method of claim 10, wherein the movement of the live element between listboxes triggers the generation of one or more aliases that are used for the animation of that live element.

12. The method of claim 10, further comprising:
an act of determining that the live element is not to inherit properties from the second, different hierarchical position in the second, different listbox; and
an act of placing the live element in a root hierarchical position in the second, different listbox.

13. The method of claim 1, wherein the live element is rendered into a data buffer which is editable by the generated aliases.

14. A computer program product for implementing a method for independently inheriting animation properties using aliases, the computer program product comprising one or more computer-readable storage media having stored thereon computer-executable instructions that, when executed by one or more processors of the computing system, cause the computing system to perform the method, the method comprising:
an act of receiving an indication that a live element is to be moved from a first position in a user interface (UI) layout to a second, different position in the UI layout;
an act of generating an alias for the live element which represents the live element in the UI layout, the UI layout comprising live element properties that are inherited hierarchically based on where the live element is positioned in the UI layout;
an act of integrating the generated alias into the UI layout, wherein the alias inherits at least one property from the live element's first position in the UI layout and at least one property from the second, different position in the UI layout;
an act of initiating an animation for the live element using the alias which is integrated into the UI layout according to the properties inherited from the first and second positions of the alias in the UI layout; and
an act of displaying the live element in the second, different position upon completion of the animation.

15. The computer program product of claim 14, wherein the alias is configured to inherit or override inheritance from any part of the hierarchy in the UI layout.

16. The computer program product of claim 15, wherein the property inheritance for each alias is customizable by a user.

17. The computer program product of claim 14, wherein the UI layout comprises a tree of live elements where each live element higher up the tree is drawn on top of the other live elements and includes additional animation properties the lower live elements do not include.

18. The computer program product of claim 14, wherein the alias is implemented to draw the live element in the second, different position with one or more new animation properties without affecting the first UI layout.

19. A computer system comprising the following:
one or more processors;
system memory;
one or more computer-readable storage media having stored thereon computer-executable instructions that, when executed by the one or more processors, causes the computing system to perform a method for maintaining layout properties when aliasing a live element, the method comprising the following:
an act of receiving an indication that a live element is to be moved from a first position in a user interface (UI) layout to a second, different position in the UI layout;
an act of removing the live element from the UI such that the live element is no longer visible on the UI;
an act of generating an alias for the live element which represents the live element in the UI layout, the UI layout comprising live element properties that are inherited hierarchically based on where the live element is positioned in the UI layout;
an act of integrating the generated alias into the UI layout, wherein the alias inherits at least one property from the live element's first position in the UI layout and at least one property from the second, different position in the UI layout;
an act of initiating an animation for the live element using the alias which is integrated into the UI layout according to the properties inherited from the first and second positions of the alias in the UI layout; and
an act of displaying the live element in the second, different position upon completion of the animation.

20. The computer system of claim 19, further comprising implementing an override inheritance flag that overrides properties inherited from the live element's position in the UI layout, wherein the override inheritance flag allows the live element to be positioned arbitrarily within the UI layout without inheriting properties based on the live element's position in the UI layout.
